(19) United States
(12) Patent Application Publication
(10) Pub. No.: US 2013/0334808 A1
(43) Pub. Date: Dec. 19, 2013

(54) ECO-FRIENDLY CARD CONSTRUCTION AND METHOD

(71) Applicants: John HAZEN, South Hadley, MA (US); Larry HOAGUE, Feeding Hills, MA (US)

(72) Inventors: John HAZEN, South Hadley, MA (US); Larry HOAGUE, Feeding Hills, MA (US)

(21) Appl. No.: 13/901,733

(22) Filed: May 24, 2013

Related U.S. Application Data
(60) Provisional application No. 61/660,218, filed on Jun. 15, 2012.

(51) Int. Cl. B42D 15/00

(52) U.S. Cl. CPC B42D 15/00
USPC 283/85; 156/305; 156/250

(57) ABSTRACT

An eco-friendly card construction includes four plies of paper stock and an adhesive between each of the four plies of paper stock, the adhesive holding the plies to one another. The card has a Sheffield smoothness of 30 or less and a thickness in the range of 27-30 mils.

### CROSS REFERENCE TO RELATED APPLICATIONS

This application claims the benefit of U.S. Provisional Application No. 61/660,218, filed Jun. 15, 2012, entitled “ECO-FRIENDLY CARD CONSTRUCTION AND METHOD”, hereby incorporated by reference in its entirety.

### FIELD OF THE INVENTION

The present invention relates generally to cards, such as transaction, information, identification and stored value cards and, more particularly, to a recyclable and repulpable stored value card and related method for making the same.

### BACKGROUND OF THE INVENTION

Plastic cards are used frequently in everyday commerce and are becoming more prevalent in a variety of applications. Plastic cards can include transaction, information, identification, and/or stored value cards, such as, for example, gift cards, debit cards, credit cards, phone cards, identification cards, driver licenses, etc. These plastic cards can include printed indica, such as a card number, identification information, expiration date, financial institution, store information, and the like, as well as artwork and other visual imagery. In addition, plastic cards, such as financial transaction cards, can include a magnetic strip that is adhered to or embossed on the card, often on the back of the card. The magnetic strip is encoded with the card information and/or account information and is configured to be read by a card reader.

As the number of cards being produced increases, the amount of scrap material resulting from processing plastic cards and from discarded plastic cards themselves continues to increase. Plastic cards are typically manufactured using a polymeric material such as polyvinyl chloride (PVC) or styrene. These materials provide the desired properties and characteristics of the plastic cards, such as, for example, rigidity, machinability, durability, appearance and feel.

Materials such as PVC and styrene, however, also have numerous negative qualities. For example, these materials are perceived as being environmentally unfriendly in that they do not biodegrade readily and have no established recycling stream. PVC, for example, raises environmental concerns with the use of vinyl chloride, phthalate plasticizers, and dioxin when such material is burned. In addition, PVC and polystyrene are made from either crude oil or natural gas, and can therefore be subject to oil price fluctuations. Moreover, certain countries and regions such as the European Union have enacted stricter waste stream regulations which limit the use of materials that may be deemed not environmentally friendly. Even plastics that are more environmentally friendly are not without at least some of these drawbacks.

As such, there is a need for a card, such as a stored value, transaction, identification card, etc., that retains the benefits of machinability, durability, appearance and feel of existing plastic cards without the environmental drawbacks typically associated with such plastic cards.

### SUMMARY OF THE INVENTION

It is an object of the present invention to provide a card such as a transaction, information, identification, and/or stored value card.

It is an additional object of the present invention to provide a paper card that has the appearance, feel, rigidity and machinability of existing plastic cards.

It is another object of the present invention to provide a paper card having a hologram.

It is another object of the present invention to provide a paper card that is recyclable and repulpable.

It is another object of the present invention to provide a paper card that complies with “green” or environmentally friendly waste stream regulations.

It is another object of the present invention to provide a method for manufacturing a card such as a transaction, information, identification, and/or stored value card having the machinability, appearance and feel of a plastic card.

It is another object of the present invention to provide a method for manufacturing a card that is recyclable and repulpable.

An embodiment of the inventive eco-friendly card construction includes four plies of paper stock and an adhesive between each of the four plies of paper stock, the adhesive holding the plies to one another. The card has a Sheffield smoothness of 30 or less and a thickness in the range of 27-30 mils.

These and other objects, features and advantages of the present invention will become apparent in light of the detailed description of the best mode embodiment thereof, as illustrated in the accompanying drawings.

### BRIEF DESCRIPTION OF THE DRAWINGS

FIG. 1 is a top plan view of an eco-friendly card, in accordance with an embodiment of the present invention.

FIG. 2 is a detail, side elevational view of the eco-friendly card of FIG. 1, showing the construction thereof.

FIG. 3 is a flowchart illustrating a method for producing an eco-friendly card, in accordance with an embodiment of the present invention.

### DETAILED DESCRIPTION OF THE PREFERRED EMBODIMENT

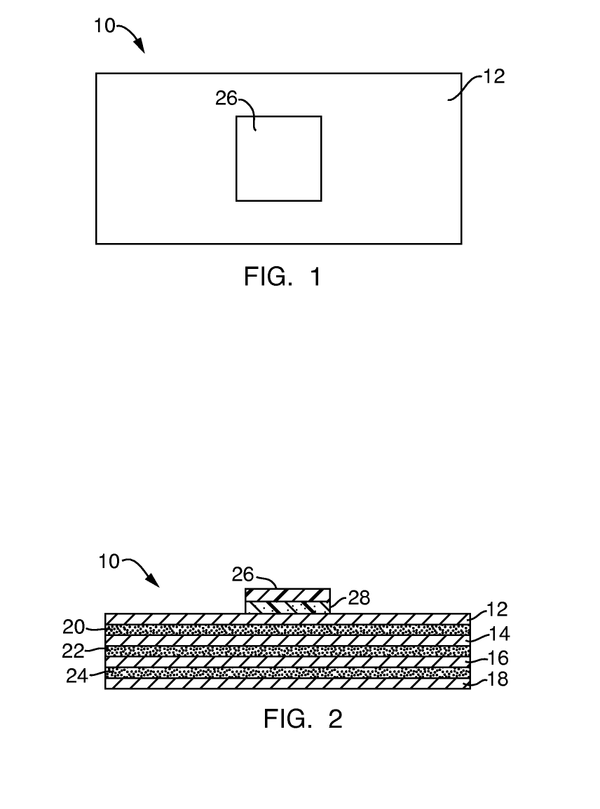

Referring to FIGS. 1 and 2, an eco-friendly card construction 10 according to the present invention is shown. The card 10 includes a plurality of plies of paper stock that are held together with an adhesive between each ply. The paper stock may be one of numerous types of paper stock known in the art, but in any event the paper stock is recyclable and repulpable. In the preferred embodiment, there are four plies 12, 14, 16, 18 of paper stock that are bound together with adhesive layers 20, 22, 24 therebetween. In particular, as shown in FIG. 2, ply 12 is bound to ply 14 by adhesive layer 20, ply 14 is bound to ply 16 by adhesive layer 22 and ply 16 is bound to ply 18 by adhesive layer 24. As further shown therein, a holographic lamination 26 containing a hologram is bound to the top ply 14 by a holographic lamination adhesive layer 28.

In the preferred embodiment, the card 10 has a Sheffield smoothness of 30 or lower and a caliper in the range of 27-30 mils, and more preferably 30 mils. Importantly, it has been discovered that a four-ply paper stock card having these smoothness and thickness ranges has the appearance, feel, rigidity and machinability of existing plastic cards. As will be readily appreciated, the machinability of the card is important, as a press-ready sheet of material from which the cards are machined is often shipped to downstream printing companies who print text or images on the sheet and cut the cards from the press-ready sheet. Moreover, the appearance and feel of the card is important to consumers who have become used to the look and feel of plastic cards, and who may perceive rough, thin and malleable cards as cheap. In addition, the durability of the card 10 resulting from the four ply construction and the specific thickness and smoothness values noted above is crucial, especially for cards such as debit, credit or gift cards that may be run through a card reader numerous times throughout their life.

As noted above, the particular construction of the card 10 gives the card the machinability, appearance and feel of existing plastic cards, which have a certain appeal because of these features. In addition, in contrast to existing plastic cards, however, the card 10 of the present invention is environmentally friendly in that it is both recyclable and repulpable. Accordingly, the card 10 may be recycled and remade into other cards or other paper products, and does not contribute to environmental degradation like existing plastic cards do.

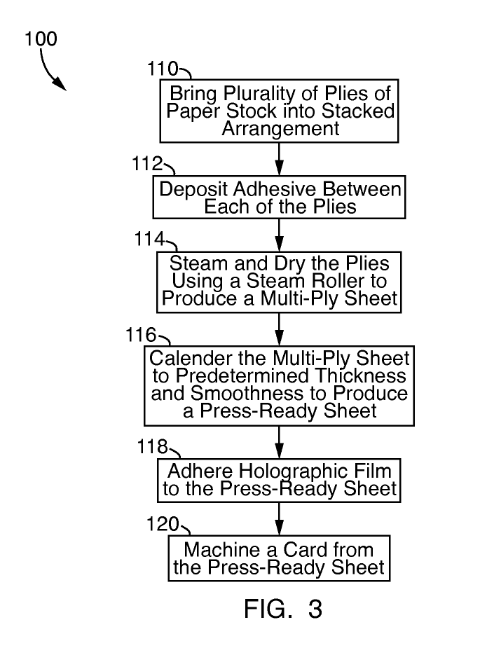

With reference to FIG. 3 a method 100 for manufacturing an eco-friendly card is illustrated. As shown therein, at step 110, the four plies of paper stock 12, 14, 16, 18 are simultaneously unwound from rolls and brought into stacking alignment with one another. Adhesive is then applied between the plies in a manner known in the art, at step 112, in order to bond the plies 12, 14, 16, 18 together. At step 114, the adhered plies are steamed and dried utilizing steam rollers. Finally, the dried plies are calendered, at step 116, by passing the plies through an array of calender rollers in order to precisely control thickness and smoothness of the resulting press-ready sheet.

After passing through the calender rollers, the press-ready sheet can be examined to ensure that the specifications of the sheet fall within preferred parameter ranges. In particular, the sheet may be examined to determine internal moisture, thickness and smoothness, which directly result in giving the press-ready sheet the look, feel and durability of a plastic card. In the event that any one or more of the internal moisture, thickness and smoothness is not within ideal ranges, the calender rollers and other components of the apparatus can be adjusted until the resultant press-ready sheet falls within the preferred parameter ranges.

After the press-ready sheet having the look, feel, rigidity and durability of a plastic card is produced, it can be cut and shipped directly to downstream processing companies for printing, inlaying of a magnetic strip, etc. Alternatively, however, a hologram may be laminated to the surface of the sheet at predetermined locations. In particular, at step 118, a holographic film 26 containing a hologram is bound to the top ply of the press-ready sheet by a holographic lamination adhesive layer 28. In an embodiment, the hologram is a transfer layer of metal that is bound to the top ply of the sheet using a transfer film, as is known in the art. In any event, the press-ready sheet with or without the hologram can be cut into cards, at step 120, or can be shipped to customers or down stream processors for ink printing, cutting to shape, etc.

In an embodiment, a transfer layer of metal may be adhered to the press-ready sheet utilizing any technology or method known in the art. After the transfer layer of metal is adhered to the press-ready sheet, repeating or different holographic images may be imaged/printed on the sheet at predetermined locations utilizing methods known in the art. As will be readily appreciated, as discussed above, it is important that the holographic images be precisely located on the press-ready sheet so that these images may be centered or otherwise properly positioned on the finished and cut eco-friendly card.

Importantly, the eco-friendly card 10 of the present invention is intended to replace existing plastic cards that are environmentally unfriendly. In particular, the card 10 of the present invention may be a transaction, information, identification, and/or stored value card, such as, for example, gift cards, debit cards, credit cards, phone cards, identification cards, driver licenses, etc.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. An eco-friendly card construction, comprising:
a plurality of plies of paper stock;
an adhesive between each of said plies, said adhesive holding said plies together; and
a holographic film adhered to one of said plurality of plies.

2. The eco-friendly card construction of claim 1, wherein:
said plurality of plies is exactly four plies.

3. The eco-friendly card construction of claim 1, wherein:
said card construction has a Sheffield smoothness of 30 or lower.

4. The eco-friendly card construction of claim 3, wherein:
said card construction has a thickness in the range of 27-30 mils.

5. The eco-friendly card construction of claim 3, wherein:
said card construction has a thickness of 30 mils.

6. The eco-friendly card construction of claim 1, wherein:
said card construction is recyclable and repulpable.

7. The eco-friendly card construction of claim 1, wherein:
said card construction has the appearance, feel, durability and machinability of a plastic card.

8. The eco-friendly card construction of claim 1, wherein:
said card is a stored-value card.

9. The eco-friendly card construction of claim 1, wherein:
said card is an identification card.

10. A card, comprising:
four plies of paper stock; and
adhesive between each of said four plies of paper stock, said adhesive holding said plies to one another;
wherein said card has a Sheffield smoothness of 30 or less; and
wherein said card has a thickness in the range of 27-30 mils.

11. The card of claim 10, comprising:
a holographic film adhered to one of said plurality of plies.

12. The card of claim 10, wherein:
said card is recyclable and repulpable.

13. The card of claim 10, wherein:
said card has the appearance, feel, durability and machinability of a plastic card.

14. The card of claim 10, wherein:
said card is a stored value card.

15. A method of manufacturing an eco-friendly card, said method comprising the steps of:
bringing four plies of paper stock into stacking arrangement with one another;
depositing an adhesive between said plies;
adhering said plies to one another; and
calendaring said plies to a thickness of 27-30 mils and a Sheffield smoothness of 30 or less to produce a press-ready sheet.

16. The method according to claim 15, wherein:
said step of adhering said plies to one another includes steaming said plies using a steam roller; and
drying said plies.

17. The method according to claim 15, further comprising the step of:
adhering a holographic film to one of said plies.

18. The method according to claim 15, wherein:
said paper stock is recyclable and repulpable.

19. The method according to claim 15, further comprising the step of:
machining a card from said press-ready sheet.

20. The method according to claim 15, further comprising the step of:
inlaying a magnetic stripe on a back of said press-ready sheet.
